(19) United States
(12) Patent Application Publication
(10) Pub. No.: US 2015/0041356 A1
(43) Pub. Date: Feb. 12, 2015

(54) COVER SHEET FOR PILL RECEPTACLE, PILLBOX KIT COMPRISING SAME AND METHOD OF GAINING ACCESS TO A PILL COMPARTMENT

(71) Applicant: Richards Packaging Inc. - Emballages Richards Inc., Mississauga (CA)

(72) Inventor: Marie-Josee Glaude, Lachine (CA)

(73) Assignee: Richards Packaging Inc. - Emballages Richards Inc., Mississauga (CA)

(21) Appl. No.: 13/962,335

(22) Filed: Aug. 8, 2013

(51) Int. Cl. A61J 1/03; B65B 69/00; B65D 75/32

(52) U.S. Cl. CPC A61J 1/03; B65D 75/327; B65B 69/0058
USPC 206/532; 428/43; 53/492

(57) ABSTRACT

The pillbox comprises a pill receptacle comprising a number of pill compartments and a cover sheet attached to the pill receptacle that has a number defined by borders above each pill compartment. Tearable tab tearing lines are provided on the sealing sheet to form tearable tabs, and each comprises main portion side segments that define a tearable tab main portion therebetween; tongue portion side segments that define a tearable tab tongue portion therebetween, the tearable tab tongue portion linking the tearable tab main portion to one of the cell borders; and a main portion end segment that links the main portion side segments to each other spacedly from the tongue portion. The tearable tabs can be torn away from the remainder of the sealing sheet to allow access to the pill compartments, the tearing of the tearable tab being initiated by either one of grasping the tearable tab tongue portion and peeling the tearable tab away along the tearable tab tongue portion side segments and the tearable tab main portion side segments; and punching the tearable tab in by applying pressure on the tearable tab main portion, with the sealing sheet then tearing along at least one of the tearable tab main portion side segments and the tearable tab main portion end segment. When the tearable tab is punched in, the sealing sheet can alternately tear along a tearable tab intermediate segment in addition to or instead of at least one of the tearable tab main portion side segments and the tearable tab main portion end segment.

### FIELD OF THE INVENTION

The present invention relates to pillboxes of the type that comprise a pill receptacle for receiving pills and a cover sheet that can cover and seal the pill receptacle.

### BACKGROUND OF THE INVENTION

Medical institutions and pharmacists often distribute numerous pills to patients for consumption. Pillboxes have been developed to facilitate the storage and dispensing of the pills to the patients.

Typical prior art pillboxes include a pill receptacle having twenty-eight pill compartments arranged in seven rows each representing one day of the week and four columns each representing one timeslot of the day, typically that of breakfast, lunch, dinner and bedtime slots. Such a pillbox will be filled by a pharmacist or other medical professional, and used by a patient or a medical professional such as a nurse who dispenses the medication to a patient, on a given week.

Pills are initially inserted into the pill compartments in such a way as to be organized according to a patient's prescription or schedule. Once the pill receptacle is filled with pills, a cover sheet is used to cover the pill receptacle to enclose the pills in their respective compartments. More particularly, the cover sheet is glued on the top surface of the pill receptacle to seal each individual pill compartment.

Depending on the type of glue that is used, the cover sheet may be either a temporary cover sheet or a permanent cover sheet. A temporary cover sheet uses glue that creates a weaker bond between the cover sheet and the pill receptacle to allow a portion of the cover sheet to be partly or completely removed to access each of the pill compartments, and then reattached to seal the pill compartments again, repeatedly. A permanent cover sheet uses glue that creates a stronger bond between the cover sheet and the pill receptacle such that when the cover sheet is affixed to the pill receptacle, it will not be possible to remove the cover sheet without tearing the sheet since the bond between the cover sheet and the pill receptacle is stronger than the cover sheet itself making reattachment ineffective after tearing. Permanent cover sheets are of particular interest in the case of the present invention.

To access a pill compartment covered by a permanent cover sheet, one needs to tear the cover sheet over the selected pill compartment. This tearing of the cover sheet to access the pills is desirable since it allows the person handling the pillboxes to visually confirm whether a pill compartment was accessed or not. To facilitate the tearing of the cover sheet above a specific pill compartment and to prevent the cover sheet from accidentally and undesirably tearing above other pill compartments the access to which is not desired yet, tearing lines are provided on the cover sheet in register with each pill compartment. When the cover sheet is torn, it will tear along the predictable paths created by these weaker tearing lines that form tearable tabs. The tearing lines are usually either discrete perforations made along a line, continuous cut-away lines, or a number of successive short cut-away lines that form a dashed line configuration. One example of a prior art cover sheet is shown in applicant's Canadian Patent No. 2,207,045.

As shown in FIGS. 5 and 7 on the '045 patent in particular, the cover sheet more particularly comprises a sealing sheet that is formed with the above-mentioned tearing lines and that is glued to the pill receptacle, and with protective tabs provided on the glue-covered surface of the sealing sheet that are shaped to register with the pill compartments. Once the sealing sheet is attached to the pill receptacle, each protective tab will be located above a pill compartment to prevent the pills from coming into contact with the glue-covered surface of the bottom of the sealing sheet. The tearing lines of the sealing sheet will consequently be aligned with and located directly over the contour of the underlying protective tabs. When the sealing sheet is torn to access the pills in a given pill compartment, a tearable tab will be torn along tearing lines that register with the protective tab edges and with the pill compartment side walls.

The cover sheet is formed of two layers: the sealing sheet to which is attached a protective sheet. The protective sheet covers the entire bottom, glue-covered surface of the sealing sheet to avoid the sealing sheet from undesirably attaching to any and all surfaces it comes in contact with during production, storage, transportation and manipulation, before it is attached to a pill receptacle. A silicon liner is provided on the protective sheet to allow it to be easily releasable from the glue-covered surface of the sealing sheet. Protective tab tearing lines on the protective sheet allow a portion of the protective sheet to be removed by being peeled away from the sealing sheet while other portions of the protective sheet will remain attached to the sealing sheet in the form of the protective tabs.

During the manufacture of the cover sheet, the protective tabs are formed in alignment with the tearing lines of the sealing sheet. In some prior art devices, this is done with two cutting tools, one over the sheet and one under the sheet, that are aligned with each other to have the tearing lines of the protective sheet and the tearing lines of the sealing sheet made in register with each other. In other prior art devices, this alignment is achieved concurrently with a same cutting tool that extends through both sheets.

The protective tabs generally having the same size as the tearable tabs was up to now seen as common wisdom. Indeed, if the protective tabs were smaller than the tearable tabs, then a portion of the tearable tabs' glue-covered bottom surface would be exposed and the pills could undesirably come into contact with the glue. On the other hand, if the protective tabs were larger than the tearable tabs, then tearing the tearable tabs would be more difficult as the protective tabs would in fact reinforce the overlying sealing sheet at the tearable tab tearing line positions.

It has been found that prior art tabs often hinder the tearing of the sealing sheet due to its frictional engagement against the edges of the remainder of the sealing sheet that are created when the tearable tab is torn above a pill compartment. Indeed, the protective tab having the same size as the tearable tab means that, in effect, the protective tab will slide along the sealing sheet edges and, since the user may not tear the tearable tab in a perfectly aligned fashion, this sliding effectively results in contact between the protective tab and the sealing sheet edges. What is more problematic is that this frictional engagement will sometimes result in the protective tab accidentally peeling away from the cover sheet, exposing the glue covered surface of the cover sheet and possibly allowing the pills to come into contact with the glue. This accidental detachment of the protective tab from the sealing sheet's tearable tab is notably due to the silicon liner on the protective tabs that makes it relatively easy to peel it away.

On another note, one may initiate the tearing of the tearable tabs of prior art sealing sheets either by grasping protruding edges of the tearable tabs and peeling them away from the remainder of the sealing sheet, or by punching them into the pill compartment. In both cases, once at least part of the tearable tab is torn, the tearable tab may then be torn away completely. Different cover sheets have respective tearing line configurations to allow for one of these different tearing initiating options, i.e. peeling or punching in, but not both.

Initiating the tearing of the tearable tab by punching it in requires that the user push on the tearable tab inwardly into the pill compartment, for example with the user's index finger, until the tearable tab is torn from the remainder of the sealing sheet and forced into the pill compartment. The user may then grasp the tearable tab portion that is accessible due to the opening formed when it was punched in, for example between the user's thumb and index finger, to peel or shear the tearable tab and remove it entirely from the remainder of the sealing sheet. To allow the punching in of the tearable tab, the tearable tab is formed by tearing lines that form a closed loop, for example of rectangular shape that corresponds to the contour of the underlying pill compartment, to allow the tearable tab to tear all around the pill compartment edges and be entirely removed. Alternately, the tearable tab can be only partly torn away to access the pill compartment by folding it away from the pill compartment, the tearable tab then remaining partly attached to the remainder of the sealing sheet.

Initiating the tearing of the tearable tab by peeling it requires the user to grasp a protruding edge of the tearable tab, for example between the user's thumb and index fingers, and pull upwardly away from the pill receptacle. This protruding edge is provided in the form of a tongue at a first end of the peelable tab, to facilitate grasping of the peelable tab for peeling it away. The peelable tab is provided with a pair of parallel tearing lines that allow the peelable tab to tear along two sides of the pill compartment. The peelable tab normally remains attached to the sealing sheet at its second end, opposite the tongue, since the absence of a transversal tearing line means that the tearable tab could tear in an undesirable irregular pattern if transversal tearing was attempted. Consequently, this prior art method normally is not intended to allow the tearable tab to be entirely removed from the remainder of the sealing sheet.

It has been found that some users prefer using one or the other of the two tearing methods. For example, elderly patients that need to tear the tearable tab themselves to access their pills, usually find that punching the tearable tab in is easier since it does not require any minute handling of the tearable tab tongue. However, in the case where the pill compartment is completely filled with pills, punching the tearable tab in can be very difficult since the pills will act to support the tearable tab from underneath. So by offering a single option to the users, results in imperfect solutions in some circumstances.

### SUMMARY OF THE INVENTION

The invention relates to a cover sheet for use with a pill receptacle, comprising:
a sealing sheet having top and bottom surfaces and an adhesive on said bottom surface for attachment to the pill receptacle, said sealing sheet comprising at least one cell circumscribed by borders, said cell borders defined by either one of
   peripheral edges of an outer periphery of said sealing sheet;
   cell tearing lines located interiorly of said peripheral edges; and
   a combination thereof;
tearable tab tearing lines on said sealing sheet that are disposed to form tearable tabs on said sealing sheet, with said tearable tab tearing lines comprising, for each said tearable tab:
   spaced-apart main portion side segments that define a tearable tab main portion therebetween;
   spaced-apart tongue portion side segments that define a tearable tab tongue portion therebetween, said tearable tab tongue portion further defined between said tearable tab main portion and at least one of said cell borders; and
   a main portion end segment that links said main portion side segments to each other spacedly from said tongue portion, with said tearable tab main portion further defined between said main portion end segment and said tearable tab tongue portion;
      wherein each said tearable tab can be torn away from the remainder of said sealing sheet, with tearing said tearable tab being initiated by either one of:
peeling said tearable tab at least along said tearable tab tongue portion side segments and said tearable tab main portion side segments; and
punching said tearable tab in, with said sealing sheet then being torn at least along one of said tearable tab main portion side segments and said tearable tab main portion end segment.

In one embodiment, said cell borders comprise both said cell tearing lines and said sealing sheet peripheral edges, and wherein said cell borders divide said sealing sheet into a number of cells each enclosing respective said tearable tabs, with said tearable tab tongue portions linking corresponding said tearable tab main portions to corresponding said cell borders.

In one embodiment, said cell tearing lines comprise said main portion end segments.

In one embodiment, said main portion end segments are distinct and spaced from said cell tearing lines.

In one embodiment, said cover sheet further comprises a protective sheet removably attached to said bottom surface of said sealing sheet, and protective tab tearing lines on said protective sheet that allow a portion of said protective sheet to be removed from said sealing sheet while other portions of said protective sheet will remain attached to said sealing sheet in the form of protective tabs that correspond to respective tearable tabs such that said protective tabs will remain attached to said tearable tabs when said tearable tabs are torn.

In one embodiment, said sealing sheet further comprises folding lines made on said tearable tabs.

In one embodiment, said tearable tab tongue portions are wider than said protective tab tongue portions.

In one embodiment, said tearable tab tongue portion side segments are concave.

In one embodiment, said tearable tab tearing lines further comprise, for each tearable tab, an intermediate segment extending between said main portion side segments spacedly away from said main portion end segment towards said tearable tab tongue portion, such that when said tearable tabs are punched in, said sealing sheet can tear along said tearable tab intermediate segment instead of or in addition to tearing along at least one of said tearable tab main portion side segments and said tearable tab main portion end segment.

In one embodiment, said intermediate segment is located between said tearable tab main portion and said tearable tab tongue portion, and is curved and concave towards said tearable tab end segment.

In one embodiment, said intermediate segment is located between said tearable tab main portion and said tearable tab tongue portion, and is substantially straight.

The present invention further relates to a pillbox kit comprising:
a pill receptacle comprising a number of pill compartments; and
a cover sheet comprising:
   a sealing sheet having top and bottom surfaces and an adhesive on said bottom surface for attachment to the pill receptacle, said sealing sheet comprising at least one cell circumscribed by borders, said cell borders defined by either one of:
      peripheral edges of an outer periphery of said sealing sheet;
      cell tearing lines located interiorly of said peripheral edges; and
      a combination thereof;
   tearable tab tearing lines on said sealing sheet that are disposed to form tearable tabs on said sealing sheet, with said tearable tab tearing lines comprising, for each said tearable tab:
      main portion side segments that define a tearable tab main portion therebetween;
      tongue portion side segments that define a tearable tab tongue portion therebetween, said tearable tab tongue portion further defined between said tearable tab main portion and at least one of said cell borders; and
      a main portion end segment that links said main portion side segments to each other spacedly from said tongue portion, with said tearable tab main portion further defined between said main portion end segment and said tearable tab tongue portion;
         wherein when said sealing sheet is attached to said pill receptacle by applying said bottom surface with said adhesive on said pill receptacle, said tearable tabs will be located over corresponding pill compartments, and each said tearable tab can then be torn away from the remainder of said sealing sheet to allow access to said pill compartments, with tearing said tearable tab being initiated by either one of
peeling said tearable tab at least along said tearable tab tongue portion side segments and said tearable tab main portion side segments; and
punching said tearable tab in, with said sealing sheet then being torn at least along one of said tearable tab main portion side segments and said tearable tab main portion end segment.

In one embodiment, said cell borders comprise both said cell tearing lines and said sealing sheet peripheral edges, and wherein said cell borders divide said sealing sheet into a number of cells each enclosing respective said tearable tabs, with said tearable tab tongue portions linking corresponding said tearable tab main portions to corresponding said cell borders.

In one embodiment, said cell tearing lines comprise said main portion end segments.

In one embodiment, said main portion end segments are distinct and spaced from said cell tearing lines.

In one embodiment, said cover sheet further comprises a protective sheet removably attached to said bottom surface of said sealing sheet, and protective tab tearing lines on said protective sheet that allow a portion of said protective sheet to be removed from said sealing sheet while other portions of said protective sheet will remain attached to said sealing sheet in the form of protective tabs that correspond to respective tearable tabs such that said protective tabs will remain attached to said tearable tabs when said tearable tabs are torn and will be located above a corresponding pill compartment.

In one embodiment, said sealing sheet further comprises folding lines made on said tearable tabs.

In one embodiment, said tearable tab tongue portions are wider than said protective tab tongue portions.

In one embodiment, said tearable tab tongue portion side segments are concave.

In one embodiment, said tearable tab tearing lines further comprise, for each tearable tab, an intermediate segment extending between said main portion side segments and located spacedly away from said tearable tab end segment towards said tearable tab tongue portion, such that when said tearable tabs are punched in, said sealing sheet can tear along said tearable tab intermediate segment instead of or in addition to tearing along at least one of said tearable tab main portion side segments and said tearable tab main portion end segment.

In one embodiment, said intermediate segment is located between said tearable tab main portion and said tearable tab tongue portion, and is curved and concave towards said tearable tab end segment.

In one embodiment, said intermediate segment is located between said tearable tab main portion and said tearable tab tongue portion, and is substantially straight.

In one embodiment, said pill receptacle comprises receptacle tearing lines defining a number of detachable pill containers each circumscribing a corresponding said pill compartment, each said cell overlying a corresponding said pill container with said cell tearing lines being aligned with corresponding receptacle tearing lines, said pill containers comprising a peripheral wall, an upper flange linked to said peripheral wall and a top mouth opening defined interiorly of said upper flange and allowing access into said pill compartment, with said top mouth opening being larger than said tearable tab.

In one embodiment, said tearable tab tearing lines are aligned with an inclined portion of said peripheral wall.

In one embodiment, said peripheral wall comprises a chamfer near said top flange and said tearable tab tearing lines are aligned with and spaced from said chamfer.

The present invention also relates to a method of gaining access to a pill compartment defined within a pill container to which a sealing sheet cell is attached to seal off said pill compartment, said sealing sheet cell circumscribed by borders and comprising tearable tab tearing lines that are disposed to form a tearable tab, said tearable tab tearing lines comprising:
main portion side segments that define a tearable tab main portion therebetween;
tongue portion side segments that define a tearable tab tongue portion therebetween, said tearable tab tongue portion further defined between said tearable tab main portion and at least one of said cell borders; and
a main portion end segment that links said main portion side segments to each other spacedly from said tongue portion, with said tearable tab main portion further defined between said main portion end segment and said tearable tab tongue portion;
   wherein said method comprises tearing said tearable tab away from the remainder of said sealing sheet cell, said tearing being initiated by one of
peeling said tearable tab at least along said tearable tab tongue portion side segments and said tearable tab main portion side segments; and
punching said tearable tab in, with said sealing sheet cell then being torn along at least one of said tearable tab main portion side segments and said tearable tab main portion end segment.

In one embodiment, said tearable tab tearing lines further comprise, for each tearable tab, an intermediate segment extending between said main portion side segments and located spacedly from said main portion end segment towards said tearable tab tongue portion, such that when said tearable tabs are punched in, said sealing sheet can tear along said tearable tab intermediate segment in addition to or instead of at least one of said tearable tab main portion side segments and said tearable tab main portion end segment.

In one embodiment, said cell tearing lines comprise said main portion end segments.

In one embodiment, said main portion end segments are distinct and spaced from said cell tearing lines.

### DESCRIPTION OF THE DRAWINGS

In the annexed drawings:

FIG. 1 is a perspective view of a pillbox according to the present invention wherein the cover sheet is partly installed on the pill receptacle, namely with its top portion glued to the pill receptacle and with a lower portion folded away from the pill receptacle and not yet affixed thereto;

FIGS. 2 and 3 are respectively top and bottom perspective views of the cover sheet forming part of the pillbox kit which is assembled to form the pillbox of FIG. 1;

FIG. 4 is an enlarged top plan view of one individual pill container detached from the remainder of the pillbox, the pill container covered by a cell of the sealing sheet;

FIG. 5 is an enlarged perspective view of the individual pill container and sealing sheet cell of FIG. 4 with the tearable tab peeled away to allow access to pills, shown in dashed lines, and with the tearable tab being shown underneath the tearable tab;

FIGS. 6 and 7 are enlarged cross-sectional views respectively taken along lines VI-VI and VII-VII of FIG. 4;

FIG. 8 is an enlarged view of the area circumscribed by line VIII in FIG. 7;

FIGS. 9 and 10 are similar to FIGS. 2 and 4, respectively, but show an alternate embodiment of the present invention; and

FIGS. 11 and 12 are similar to FIGS. 2 and 4 and to FIGS. 9 and 10, but show yet another embodiment of the invention.

### DETAILED DESCRIPTION OF THE EMBODIMENTS

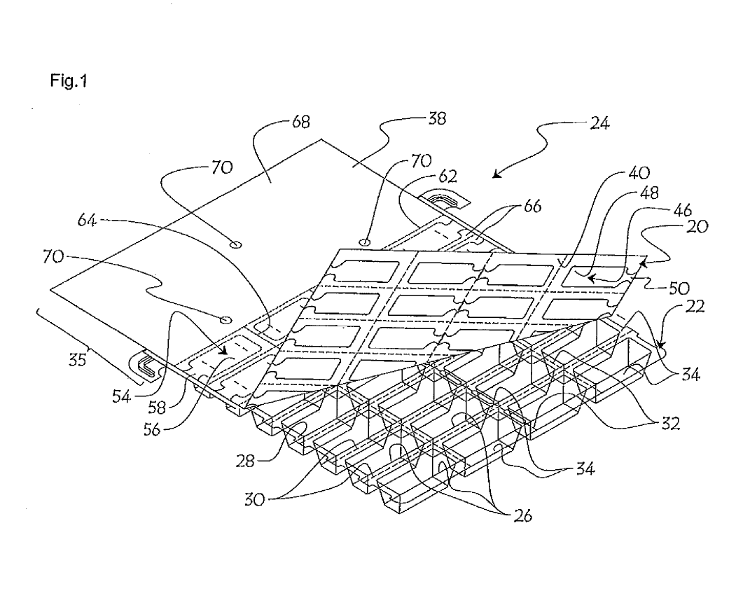

FIGS. 1-3 show a cover sheet 20 for use with a pill receptacle 22 according to the present invention. When assembled, cover sheet 20 and pill receptacle 22 form a pillbox 24 as described herein below. When not assembled, cover sheet 20 and pill receptacle 22 may form a pillbox kit that may be assembled to create pillbox 24.

As shown in FIG. 1, pill receptacle 22 is made from a unitary sheet of plastic embossed to create a number of pill compartments 26 wherein pills may be inserted as described herein below. Pill receptacle 22 defines a flat top surface 28 and a number of first and second pill receptacle tearing lines 30, 32 that cross each other at right angles to form rectangular detachable individual pill containers 34 arrayed in seven rows and four columns. It is understood that any number of rows and columns may be formed and detachable pill containers 34 may have any suitable shape to receive the pills. Above the uppermost first pill receptacle tearing line 30 is also defined a pill receptacle top marginal portion 35 used for assembling and identifying the pillbox 24, as described hereinafter.

It is consequently possible for a user to detach each individual detachable pill container 34 from the remainder of the pill receptacle 22 by tearing the container along the first and second pill receptacle tearing lines 30, 32 that define it, to allow individual pill doses to be distributed to patients without having to bring the entire pillboxes 24 to the patients.

FIGS. 1-3 show that cover sheet 20 comprises a sealing sheet 36 having top and bottom surfaces 38, 40. An adhesive is provided on at least a portion of bottom surface 40 for attachment to the pill receptacle 22.

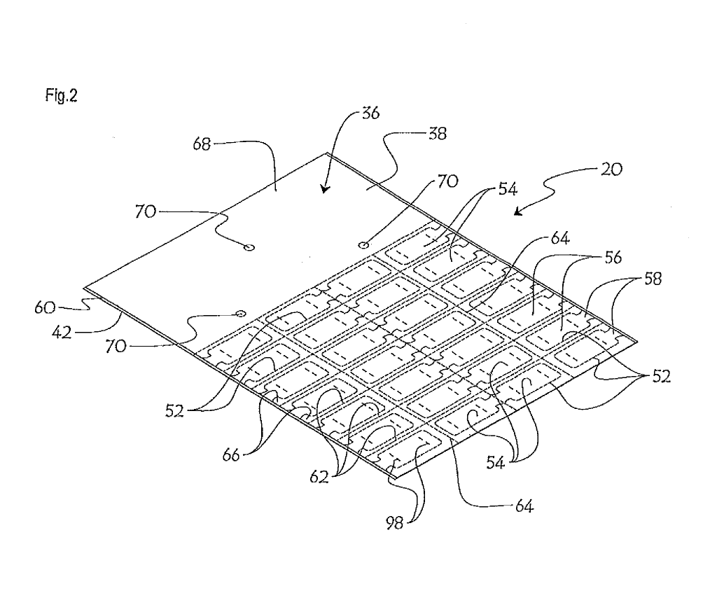

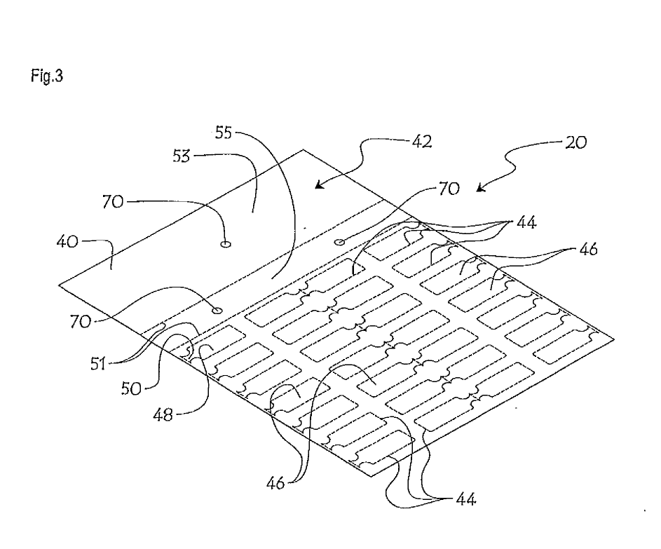

FIGS. 2-3 show that cover sheet 20 also comprises a protective sheet 42 removably attached to sealing sheet 36 on its bottom surface 40. Protective sheet 42 is provided with a silicon liner on its upper surface where it is attached to sealing sheet 36, to allow protective sheet 42 to be readily releasable from the adhesive-covered bottom surface 40 of sealing sheet 36.

Protective sheet 42 comprises protective tab tearing lines 44 that allow some portions of protective sheet 42 to be removed from sealing sheet 36 while other portions of protective sheet 42 will remain attached to sealing sheet 36 in the form of protective tabs 46. In FIG. 1, only the protective tabs 46 of protective sheet 42 remain, while in FIGS. 2 and 3, the entire protective sheet 42 is shown attached to sealing sheet 36.

Each protective tab 46 comprises a generally rectangular (with rounded corners) protective tab main portion 48 and a protective tab tongue portion 50 extending from the main portion 48. The tongue portion 50 is narrower than the main portion 48 and has concave side edges. Other shapes or configurations of protective tabs 46 could also be envisioned.

Protective sheet 42 comprises a pair of protective sheet installation tearing lines 51 disposed transversally across protective sheet 42 to define a protective sheet marginal portion 53 above the topmost installation tearing line 51 and a protective sheet band 55 in-between both installation tearing lines 51. Installation tearing lines 51, band 55 and marginal portion 53 are used for assembling pillbox 24 as described hereinafter.

Sealing sheet 36 comprises tearable tab tearing lines 52 that are disposed to form tearable tabs 54 on sealing sheet 36. Each tearable tab 54 comprises a generally rectangular (with rounded corners) tearable tab main portion 56 and a tearable tab tongue portion 58 extending from the main portion 56. The tongue portion 58 is narrower than the main portion 56 and has concave side edges. Other shapes and configurations of tearable tabs 54 could also be envisioned.

Sealing sheet 36 comprises peripheral edges 60 and first and second cell tearing lines 62, 64 that cross each other at right angles with at least some of cell tearing lines 62, 64 extending from the sealing sheet peripheral edges 36. In the embodiment shown in the figures, all cell tearing lines 62, 64 extend from peripheral edges 60. Cell tearing lines 62, 64 and peripheral edges 60 divide sealing sheet 36 into cells 66 each enclosing one of the tearable tabs 54. The tearing lines 62, 64 are arrayed in seven rows and four columns and, when the sealing sheet 36 is attached to the pill receptacle 22, cell tearing lines 62, 64 lie atop and are aligned with corresponding pill receptacle tearing lines 30, 32. This allows each cell 66 to be detached from the remainder of sealing sheet 36 concurrently with the individual pill compartments 34 being detached from the remainder of the pill receptacle 22. It is understood that any number of rows and columns may be formed by cell tearing lines 62, 64 to have each cell 66 correspond to an underlying pill receptacle container portion 34.

Above the uppermost first tearable tab tearing line 62 is also defined a sealing sheet top marginal portion 68 used for assembling and identifying the pillbox 24.

Improvements of the present invention over the prior art include the configuration of the tearing lines on the sealing sheet; the relative configuration of the tearing lines of the sealing sheet with respect to those of the protective sheet, forming cooperating tearable tabs and protective tabs; and the relative configuration of the tearing lines of the sealing sheet and of the protective sheet with respect to the shape of the pill compartments. These will now be detailed.

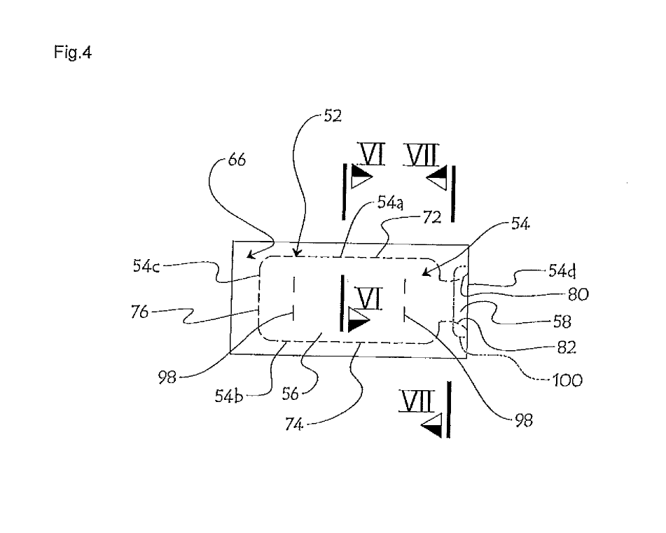

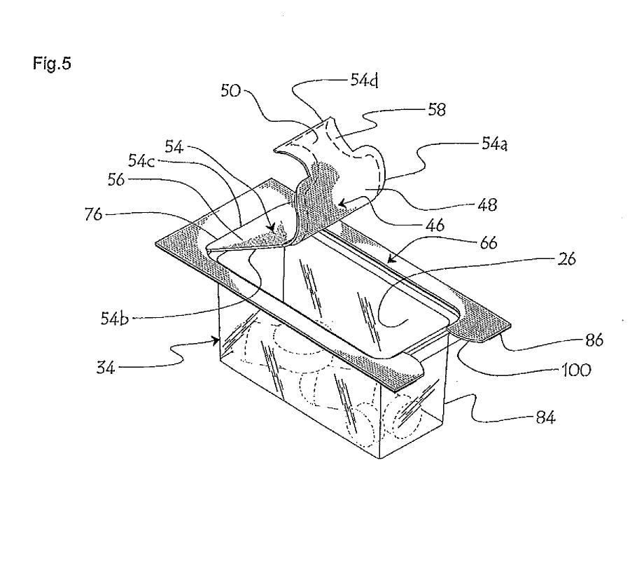

FIGS. 4 and 5 show that each tearable tab 54 defines two sides 54a, 54b and two ends 54c, 54d. FIGS. 1-5 also show that that tearable tab tongue portion 58 links main portion 56 to one of the cell tearing lines 64 and the sealing sheet peripheral edges 60. As shown particularly in FIG. 4, tearable tab tearing lines 52 comprise main portion side segments 72, 74 between which tearable tab main portion 56 is defined; and a main portion end segment 76 that links main portion side segments 72, 74 to each other, spacedly from tearable tab tongue portion 58, with tearable tab main portion 56 further defined between main portion end segment 76 and tearable tab tongue portion 58. Tearable tab tearing lines 52 also comprise tongue portion side segments 80, 82 between which tearable tab tongue portion 58 is defined; with tearable tab tongue portion 58 further defined between tearable tab main portion 56 and either one of a cell tearing line 32 and a sealing sheet peripheral edge.

Each tearable tab 54 is located in its corresponding cell 66.

The tongue portions 58 of tearable tabs 54 define concave side edges that are formed by the tongue portion side segments 80, 82 of tearable tab tearing lines 52. These concave side edges are curved and widen towards tearable tab main portion 56 to help avoid accidental tearing of tongue portion 58 from main portion 56 when tearable tab 54 is peeled, as detailed hereinafter. The concave side edges of tongue portion 58 also widen towards the tearable tab second end 54d to present an overall convergent-divergent shape.

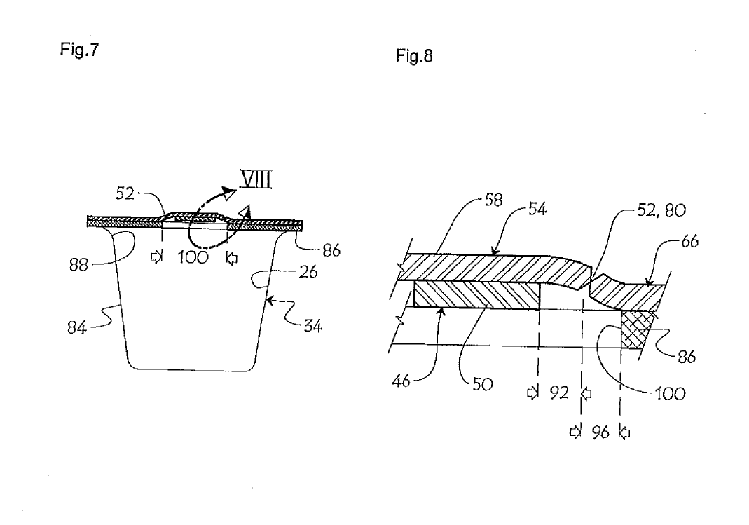

FIGS. 4-8 show that each detachable pill container 34 comprises a peripheral wall 84, an upper flange 86 linked to peripheral wall 84 and a top mouth opening defined interiorly of upper flange 86 that allows access into pill compartment 26. Peripheral wall 84 is slightly inclined as it widens towards the top of the pill compartment 34, but also because it comprises an outwardly-opening chamfer 88 near top flange 86.

As also shown in FIGS. 4-8, tearable tabs 54 are wider than protective tabs 46.

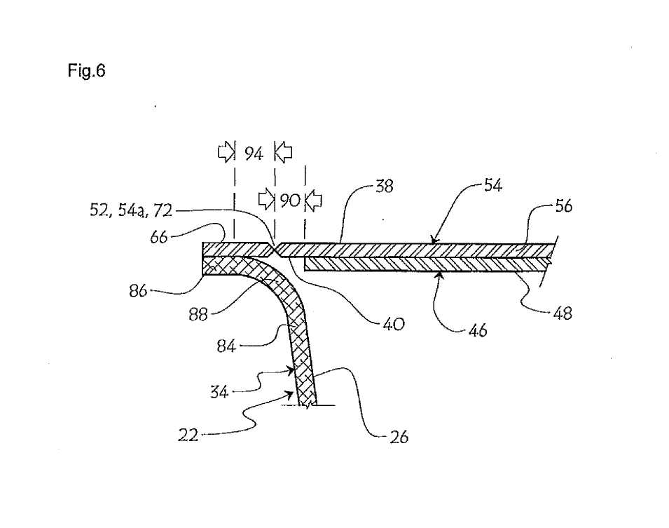

Tearable tabs 54 are wider than protective tabs 46 along the two sides 54a, 54b of the main portion 56 of tearable tabs 54, and more particularly along the two main portion side segments 72, 74. This is visible particularly in FIGS. 5 and 6. FIG. 6 shows the spacing 90 that identifies this difference in width between tearable tabs 54 and protective tabs 46 along the tearable tab main portion side segments 72, 74.

This difference in width also optionally exists at the tearable tab first end 54c, i.e. along main portion end segment 76.

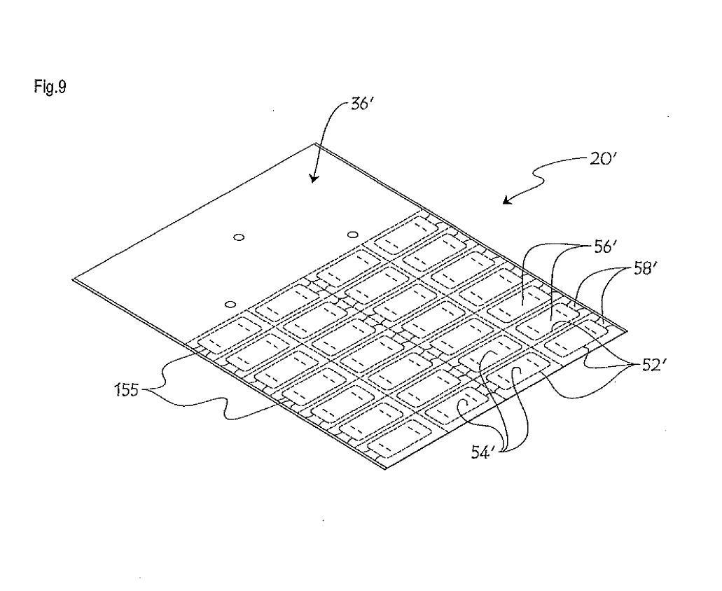

Tearable tabs 54 are also wider than protective tabs 46 in that tearable tab tongue portions 58 are wider than protective tab tongue portions 46, and more particularly along the side segments 80, 82 that define the tearable tab tongue portions 58. This is visible particularly in FIGS. 5 and 8. FIG. 8 shows the spacing 92 that identifies this difference in width in the tongue portion side segments 80, 82.

Consequently, protective tabs 46 have a contour that generally conforms to that of protective tabs 54, albeit being narrower along main portion side segments 72, 74 and along tongue portion side segments 80, 82.

The top mouth openings of the detachable pill containers 34 are larger than the tearable tabs 54. This is visible particularly in FIG. 6 where the spacing 94 exists at the tearable tab main portion 56. This is also visible in FIG. 8 where the spacing 96 exists at the tearable tab tongue portion 58.

In use, when sealing sheet 36 is attached to pill receptacle 22 by applying its adhesive-covered bottom surface 38 on pill receptacle 22 as described above, corresponding tearable tabs 54 and protective tabs 46 will be located over corresponding pill compartments 26. Tearable tabs 54 may be torn to access the pill compartments 26.

Two different ways of initiating the tearing of tearable tabs 54 are made possible according to the present invention. More particularly, tearable tabs 54 can be torn either by peeling them or by punching them in. After the tearing of a tearable tab 54 has been initiated, this tearable tab 54 may be further torn by peeling or shearing it away from the remainder of the sealing sheet 36, until the tearable tab 54 is partly or completely removed from the remainder of the sealing sheet 36 to allow access within the pill compartments 26.

Initiating the tearing of tearable tabs 54 by peeling them requires that the user grasp the tearable tab tongue portion 58, for example between his thumb and index fingers, and peel tearable tab 54 upwardly away from the pill container 34 to which its cell 66 is attached, as suggested in FIG. 5. Once the tearing has been initiated, the user may maintain his grasp on the tongue portion 58 or otherwise grasp the now accessible tearable tab main portion 56 to further tear tearable tab 54 partly or completely along tearing lines 52 by further peeling or by shearing. Tearable tab 54 may tear at least along tearable tab tongue portion side segments 80, 82 and tearable tab main portion side segments 72, 74 to allow the peeling of tearable tab 54 as shown in FIG. 5. The tearable tabs 54 may remain partly attached to cell 66, for example at main portion first end segments 76 where they will be hinged, as shown in FIG. 5; or they may be entirely detached from cell 66 in which case tearable tab end segments 76 will also be torn. In either case, the tearable tab tongue portions 58 will remain attached to the tearable tab main portions 56 when tearable tabs 54 are peeled. Access to the pill compartments 26 may then be had.

Initiating the tearing of tearable tabs 54 by punching them in requires that the user push on the tearable tabs 54 inwardly towards pill compartments 26, for example with his thumb, until the tearable tabs 54 are partly torn from the remainder of sealing sheet 36 as they are forced into pill compartments 26. Once a tearable tab 54 is partly punched in, the user may grasp the portion of tearable tab 54 that is accessible through the hole formed by the punched in tearable tab 54, for example between his thumb and index fingers, to tear the tearable tab 54 partly or entirely from the remainder of the sealing sheet 36. This second step may be accomplished for example by peeling or shearing the tearable tab 54 away from the remainder of the sealing sheet 36. When tearable tabs 54 are punched in, tearable tab tearing lines 52 can tear along tearable tab main portion side segments 72, 74, tearable tab tongue portion side segments 80, 82 and/or tearable tab main portion end segment 76, depending on where the pressure is applied by the user's finger. Tongue portions 58 will remain attached to main portion 56 and will be torn concurrently therewith.

If tearable tab 54 were to be still attached at the extremity 54d along a cell tearing line 64 to an adjacent tearable tab 54, this cell tearing line 64 would rupture to allow the targeted tearable tab 54 to be entirely torn from the remained of the sealing sheet 36. Alternately, tearable tab tongue portion 58 may be adjacent to an outer free edge of the sealing sheet 36, this outer free edge being either one of the sealing sheet's peripheral edges or an edge formed by the removal of the pill compartment 34 and cell 66 from the remainder of the pillbox 24.

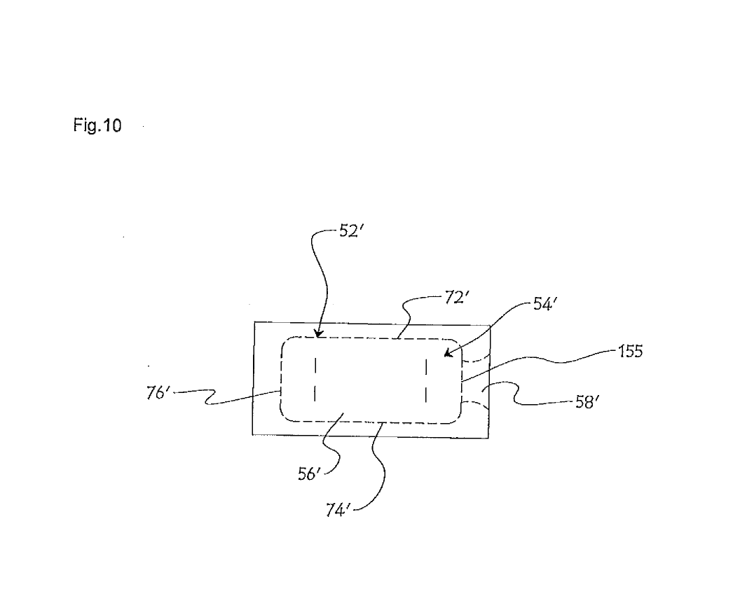

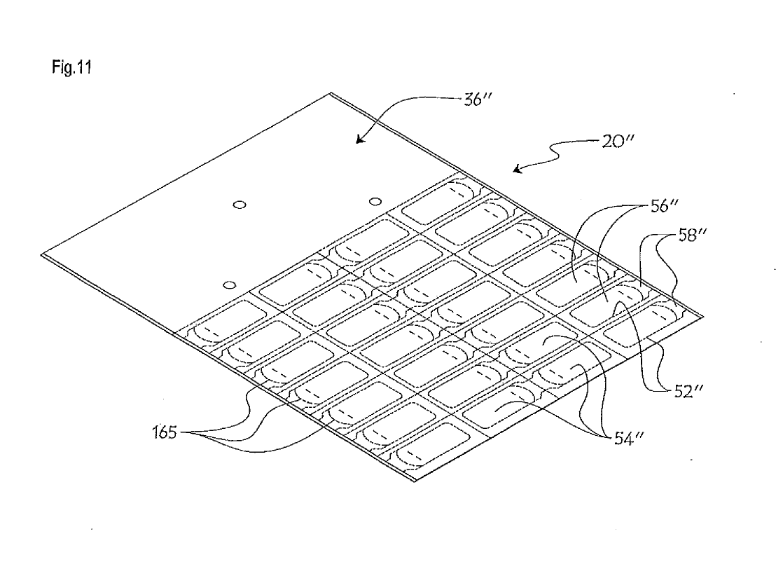

FIGS. 9 and 10 show a second embodiment of the invention wherein primed reference numbers refer to structures that are similar to the non-primed structures of the first embodiment. In the embodiment of FIGS. 9 and 10, the sealing sheet 36′ of the cover sheet 20′ comprises, for each tearable tab 54′, tearable tab tearing lines 52′ that comprise a tearable tab intermediate segment 155 that links the tearable tab main portion side segments 72′, 74′ between the main portion 56′ and the tongue portion 58′. Intermediate segment 155 is consequently substantially parallel to end segment 76′ and is located approximately above one end wall of the underlying pill container 34.

In this embodiment, intermediate segment 155 may tear when tearable tab 54′ is punched in. The user may then peel or shear the tearable tab 54′ partly or completely away from the remainder of sealing sheet 36′.

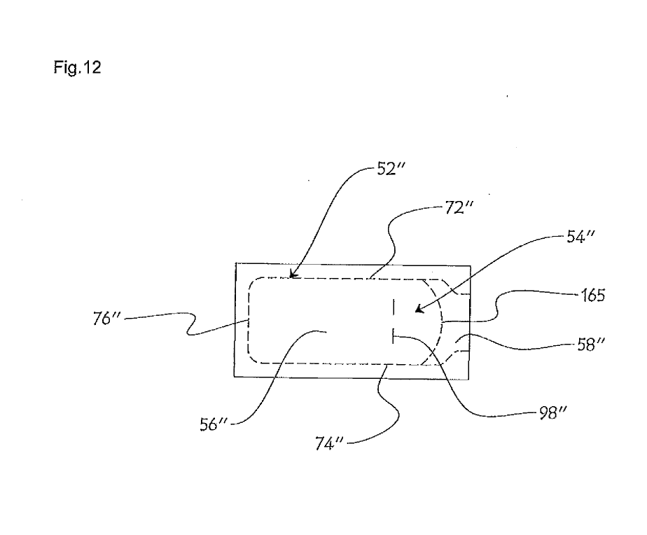

FIGS. 11 and 12 show yet a third embodiment of the invention wherein double primed reference numbers refer to structures that are similar to the non-double-primed structures of the first embodiment of FIGS. 1-8 or the single primed structures of the second embodiment of FIGS. 9 and 10. In the embodiment of FIGS. 11 and 12, a curved intermediate segment 165 is provided instead of the straight intermediate segment 155 of the second embodiment. Curved intermediate segment 165 extends between the side segments 72″ and 74″ of tearable tab 54″, and is located spacedly from the end segment 76″ towards tearable tab tongue portion 58″. FIGS. 11-12 show that intermediate segment 165 is more particularly located approximately over one end wall of the pill container 34 opposite end segment 76″, i.e. between the tearable tab main portion 56″ and the tearable tab tongue portion 58″; although it could also be located at another position, such as near the center of tearable tab main portion 56″. Intermediate segment 165 is concave towards the tearable tab main portion 56″.

FIGS. 11 and 12 further show that a tearable tab 54″ comprises a single folding line 98″, located near, albeit spacedly from, intermediate segment 165 on tearable tab main portion 56″.

Curved intermediate segment 165 may be used to punch tearable tabs 54″ in as follows: first, the user presses on the tearable tab main portion 56″ with his finger near the concave side of intermediate segment 165. This will force tearable tab 54″ to tear partly along intermediate segment 165 and possibly also partly along one or both side segments 72″, 74″. This will form a prehension edge on the tearable tab 54″ that will allow the user to grasp the partly torn tearable tab main portion 56″ between his index and thumb, to peel or shear the entire tearable tab 54″ from the remainder of the sealing sheet 36″. The folding line 98″ will help the user grasp the partly torn tearable tab main portion 56″ by allowing it to fold as compression prehension pressure is applied by the user's fingers. As shown in this embodiment, punching the tearable tab in consequently allows the tearable tab to be subsequently grasped and peeled or sheared away.

According to the invention of the first, second and third embodiments, it can consequently be seen that when a tearable tab 54, 54′ or 54″ is punched in, at least one of the tearable tab main portion side segments 72, 74, 72′, 74′, 72″, 74″, the tearable tab main portion end segment 76, 76′, 76″ or the tearable tab intermediate segments 155, 165 (if the latter are present) are torn to initiate the tearing of the tearable tab. As noted above, this will be followed by some peeling or shearing action being accomplished to partly or entirely remove the tearable tab 54 from the remainder of the sealing sheet 36.

It can consequently further be seen that, according to the present invention, tearing the tearable tabs 54 (or 54, or 54″) can be initiated by either one of the peeling or punching in of the tearable tabs 54 to yield the desired result of ultimately tearing the tearable tabs 54 from the remainder of the sealing sheet 36. The result is that users may decide to punch tearable tabs 54 in or peel them away without having to consider which teaming initiation method should be used, as both methods will work without discrimination and possibly without the users even noticing whether the cover sheet enables both methods to work. In either case, an obvious prehension edge will be formed that the used will intuitively grasp to continue the tearing of the tearable tab 54 after the tearing initiation has occurred. This means that users, such as elderly patients who can have more difficulty with the minute handling of the tearable tab tongues, can punch the tearable tab in; while other users can peel the tearable tab, for example if the pill container is filled with pills to the brim making it difficult to punch the tearable tab in.

A further advantage of the present invention relates to the fact that whether the tearable tab 54 tearing is initiated by peeling or punching, the entire tearable tab 54 may ultimately be torn away from the remainder of the sealing sheet 36, if the user so desires. This is allowed by the tearable tab 54 being defined by a closed loop that will allow this entire tearing and removal of tearable tab 54. This advantage takes particular value if a new sealing sheet should be installed over the existing one, for example if pill replacement is to be accomplished by the medical personnel handling the pill receptacle. Indeed, in such a case, the tearable tab 54 covering the pill container where pills are being replaced needs to be entirely removed to avoid hindrance of the new overlying sealing sheet.

It is noted that, in alternate configurations of the tearing lines (not shown), the tongue portion side segments 80, 82 could be coextensive with the main portion side segments 72, 74 in which case the tearable tab tongue portion 58 would be as large as the tearable tab main portion 56. Tongue portion 58 could alternately be larger than main portion 56, or could have side segments having a different shape, even though the illustrated shape with concave side edges is considered advantageous.

FIGS. 2 and 4 show that sealing sheet 36 may comprise folding lines 98 made on tearable tab main portions 56. More particularly, first and second folding lines 98, 98 are provided on tearable tab main portions 56 and they are parallel to and spaced-apart between main portion end segments 76, 78. The purpose of folding lines 98 is to facilitate grabbing the tearable tab main portion 56 when it is torn away from the remainder of sealing sheet 36 after having been punched in. Indeed, without the folding lines, the tearable tab 54 may then slip between the user's fingers; while the folding lines will help the tearable tab 54 to fold between the user's fingers when it is compressed.

As noted above, the protective tabs 46 remain attached to the tearable tabs 54 when the latter are torn, notwithstanding which of the tearing methods is being used, i.e. peeling or punching in. As noted above and according to the present invention, the tearable tabs 54 are wider than the protective tabs 46 and this avoids that the protective tabs 46 either hinder the tearing of tearable tabs 54 and also, importantly, that the protective tabs 46 be accidentally peeled away from the tearable tabs 54. Indeed, the outer edges of the protective tabs 46 will be spaced apart by a distance equal to spacing 90 relative to the inner edge of the remaining portion of the sealing sheet cell 66. This spacing 90 will avoid friction between the respective edges of the main portion 58 of protective tab 46 and the remaining portion of sealing sheet cell 66.

This is also true at the location of tearable tab tongue portion 58, namely the tearable tab tongue portion 58 is larger than the protective tab tongue portion 50 by a distance equal to spacing 92. This avoids contact between the edges of the protective tab tongue portion and the edges of the remaining portion of the sealing sheet cell 66 adjacent to tongue portion 58.

It is further noted that sealing sheet 36 is not in contact with pill receptacle 22 at the position of tearing lines 52. This is materialized at spaces 94 and 96 respectively at tearable tab main portion 56 and tongue portion 58.

More particularly, as shown in FIG. 6, this is enabled at main portion 56 by the tearable tab tearing lines 52 being aligned with an inclined portion of the pill compartment peripheral wall 84. Specifically, tearing lines 52 are aligned with and spaced from the peripheral wall chamfer 88 near its top flange 86. This positioning of tearing lines 52 allows the sealing sheet 36 to avoid being in contact with pill receptacle 22 at tearing lines 52 which would make the tearing of tearable tab 54 more difficult. However, by locating tearing lines 52 above chamfer 88, the exposed portion of the bottom surface 40 of the sealing sheet 36 that extends along spaces 90, 94, i.e. between the outer edge of protective tab 46 and the upper flange 86 of pill receptacle 22, will not be reachable by the pills and the pills will consequently not come into contact with this exposed portion of the sealing sheet bottom surface 40.

As shown in FIG. 8, the sealing sheet 36 not being in contact with pill receptacle 22 at the position of tearing lines 52 is also enabled at tearable tab tongue portion 58 by the fact that the protective sheet tongue portion 50 underlies the tearable tab tongue portion 58 in combination with the tearable tab tongue portion 58 being wider than the protective tab tongue portion 58. Even though the effective thickness of protective sheet 46 is small, this will nonetheless result in sealing sheet 36 sloping from atop protective sheet tongue portion 50 down towards the pill receptacle upper flange 86. The tongue portion side segments 80, 82 of tearing lines 52 are located in this slope, spacedly above upper flange 86.

As shown in FIGS. 4, 5, 7 and 8, a finger opening 100 is provided at one end of the pill receptacle upper flange 86 to facilitate grasping the tongue portions 50, 58 of tearable tab 54 and protective tab 46.

It is noted that cell tearing lines 62, 64 and first and second pill receptacle tearing lines 30, 32, although advantageous, are not mandatory. For one thing, a pillbox without individually detachable pill compartments (not shown) could be provided. Such a pillbox would have all tearable tab tongue portions adjacent to a peripheral edge of the pillbox. Or, alternately, individual pill compartments could be detached by cutting them away without cell tearing lines 62, 64 and first and second pill receptacle tearing lines 30, 32 to facilitate this operation. Cell tearing lines 62, 64 could be drawn on the sealing sheet 36, instead of being punched or cut therein, to identify where the cut should be made with scissors.

In the absence of cell tearing lines 62, 64, a single cell could be defined as the entire sealing sheet area 36. Thus, according to a general statement of the present invention, sealing sheet 36 comprises at least one cell circumscribed by borders, these borders being either one of:
peripheral edges of an outer periphery of the sealing sheet;
cell tearing lines located interiorly of the peripheral edges; and
a combination of the sealing sheet peripheral edges and cell tearing lines.

As can be seen in FIGS. 1-3, to assemble pillbox 24, the band 55 of protective sheet 42 is first removed. The exposed portion of the bottom glue-covered surface 40 of sealing sheet 36 is then applied against the flat top surface 28 of pill receptacle 22 at a position immediately above the uppermost pill receptacle tearing line 30. Preferably, an embossment is further made on top surface 28 to facilitate this alignment by providing a visual and tactile cue that the sheet is being properly positioned. With this alignment done, the marginal portion 53 of protective sheet 42 is then removed and the thusly additionally exposed portion of the marginal portion 68 of sealing sheet 36 is affixed to the marginal portion 35 of pill receptacle 22. A tray (not shown) may optionally be used to facilitate this first installation step. Such a tray comprises openings shaped and configured to receive the pill compartments 26 and also comprises alignment pins engageable within alignment holes 70 made through pill receptacle 22, sealing sheet 36 and protective sheet 42. The pillbox 24 may be removed from the tray at any time after the marginal portion 68 of sealing sheet is affixed to the marginal portion 35 of pill receptacle 22. At this point, the cover sheet 20 is attached only by the marginal portion 68 of sealing sheet 36 being affixed to marginal portion 35 of pill receptacle 22 and, in the remaining part of cover sheet 20, sealing sheet 36 remains protected by protective sheet 42.

Pills may then be dispensed by the appropriate medical personnel into pill compartments 26. To access the pill compartments 26, cover sheet 20 may be raised, similarly to what is shown in FIG. 1, while all pill compartments 26 are exposed, since the bottom surface 40 of the entire portion of sealing sheet that comprises cells 66 remains covered by protective sheet 42 and consequently is not attached to pill receptacle 22 yet.

Once the pills are inserted into pill compartments 26, portions of protective sheet 42 are removed from sealing sheet 36 by being peeled away such that only protective tabs 46 remain attached to the bottom surface of sealing sheet 36. The glue covered bottom surface 38 of sealing sheet 36 is then applied against and attached to the top, flat surface 28 of pill receptacle 22. With sealing sheet 36 attached to pill receptacle 22 with a strong adhesive, a so-called permanent attachment is created preventing the pill compartments from being accessed without the sealing sheet or the pill receptacle being torn or cut. The protective tabs 46 that remain attached to the bottom surface 38 of sealing sheet 36 are positioned so as to be located above each pill compartment 26 to avoid that the pills come into contact with the glue covering the sealing sheet's bottom surface 38.

The pillbox may then be distributed to other personnel who may distribute the pills to the patients by detaching the individual pill containers 34 and the associated sealing sheet cells 66 from the remainder of the pillbox 24 for distributing individual pill doses to the patients. Patient, date, medicine and other desired identification information may be printed on the top surface 38 of sealing sheet 36, both on its top marginal portion 68 and on each individual cell 66.

1. A cover sheet for use with a pill receptacle, comprising:
a sealing sheet having top and bottom surfaces and an adhesive on said bottom surface for attachment to the pill receptacle, said sealing sheet comprising at least one cell circumscribed by borders, said cell borders defined by either one of:
peripheral edges of an outer periphery of said sealing sheet;
cell tearing lines located interiorly of said peripheral edges; and
a combination thereof;
tearable tab tearing lines on said sealing sheet that are disposed to form tearable tabs on said sealing sheet, with said tearable tab tearing lines comprising, for each said tearable tab:
spaced-apart main portion side segments that define a tearable tab main portion therebetween;
spaced-apart tongue portion side segments that define a tearable tab tongue portion therebetween, said tearable tab tongue portion further defined between said tearable tab main portion and at least one of said cell borders; and
a main portion end segment that links said main portion side segments to each other spacedly from said tongue portion, with said tearable tab main portion further defined between said main portion end segment and said tearable tab tongue portion;
wherein each said tearable tab can be torn away from the remainder of said sealing sheet, with tearing said tearable tab being initiated by either one of:
peeling said tearable tab at least along said tearable tab tongue portion side segments and said tearable tab main portion side segments; and
punching said tearable tab in, with said sealing sheet then being torn at least along one of said tearable tab main portion side segments and said tearable tab main portion end segment.

2. A cover sheet as defined in claim 1, wherein said cell borders comprise both said cell tearing lines and said sealing sheet peripheral edges, and wherein said cell borders divide said sealing sheet into a number of cells each enclosing respective said tearable tabs, with said tearable tab tongue portions linking corresponding said tearable tab main portions to corresponding said cell borders.

3. A cover sheet as defined in claim 2, wherein said cell tearing lines comprise said main portion end segments.

4. A cover sheet as defined in claim 2, wherein said main portion end segments are distinct and spaced from said cell tearing lines.

5. A cover sheet as defined in claim 1, further comprising a protective sheet removably attached to said bottom surface of said sealing sheet, and protective tab tearing lines on said protective sheet that allow a portion of said protective sheet to be removed from said sealing sheet while other portions of said protective sheet will remain attached to said sealing sheet in the form of protective tabs that correspond to respective tearable tabs such that said protective tabs will remain attached to said tearable tabs when said tearable tabs are torn.

6. A cover sheet as defined in claim 1, wherein said sealing sheet further comprises folding lines made on said tearable tabs.

7. A cover sheet as defined in claim 5, wherein said tearable tab tongue portions are wider than said protective tab tongue portions.

8. A cover sheet as defined in claim 7, wherein said tearable tab tongue portion side segments are concave.

9. A cover sheet as defined in claim 1, wherein said tearable tab tearing lines further comprise, for each tearable tab, an intermediate segment extending between said main portion side segments spacedly away from said main portion end segment towards said tearable tab tongue portion, such that when said tearable tabs are punched in, said sealing sheet can tear along said tearable tab intermediate segment instead of or in addition to tearing along at least one of said tearable tab main portion side segments and said tearable tab main portion end segment.

10. A cover sheet as defined in claim 9, wherein said intermediate segment is located between said tearable tab main portion and said tearable tab tongue portion, and is curved and concave towards said tearable tab end segment.

11. A cover sheet as defined in claim 9, wherein said intermediate segment is located between said tearable tab main portion and said tearable tab tongue portion, and is substantially straight.

12. A pillbox kit comprising:
a pill receptacle comprising a number of pill compartments; and
a cover sheet comprising:
a sealing sheet having top and bottom surfaces and an adhesive on said bottom surface for attachment to the pill receptacle, said sealing sheet comprising at least one cell circumscribed by borders, said cell borders defined by either one of:
peripheral edges of an outer periphery of said sealing sheet;
cell tearing lines located interiorly of said peripheral edges; and
a combination thereof;
tearable tab tearing lines on said sealing sheet that are disposed to form tearable tabs on said sealing sheet, with said tearable tab tearing lines comprising, for each said tearable tab:
main portion side segments that define a tearable tab main portion therebetween;
tongue portion side segments that define a tearable tab tongue portion therebetween, said tearable tab tongue portion further defined between said tearable tab main portion and at least one of said cell borders; and
a main portion end segment that links said main portion side segments to each other spacedly from said tongue portion, with said tearable tab main portion further defined between said main portion end segment and said tearable tab tongue portion;
wherein when said sealing sheet is attached to said pill receptacle by applying said bottom surface with said adhesive on said pill receptacle, said tearable tabs will be located over corresponding pill compartments, and each said tearable tab can then be torn away from the remainder of said sealing sheet to allow access to said pill compartments, with tearing said tearable tab being initiated by either one of:
peeling said tearable tab at least along said tearable tab tongue portion side segments and said tearable tab main portion side segments; and
punching said tearable tab in, with said sealing sheet then being torn at least along one of said tearable tab main portion side segments and said tearable tab main portion end segment.

13. A cover sheet as defined in claim 12, wherein said cell borders comprise both said cell tearing lines and said sealing sheet peripheral edges, and wherein said cell borders divide said sealing sheet into a number of cells each enclosing respective said tearable tabs, with said tearable tab tongue portions linking corresponding said tearable tab main portions to corresponding said cell borders.

14. A cover sheet as defined in claim 13, wherein said cell tearing lines comprise said main portion end segments.

15. A cover sheet as defined in claim 13, wherein said main portion end segments are distinct and spaced from said cell tearing lines.

16. A cover sheet as defined in claim 12, further comprising a protective sheet removably attached to said bottom surface of said sealing sheet, and protective tab tearing lines on said protective sheet that allow a portion of said protective sheet to be removed from said sealing sheet while other portions of said protective sheet will remain attached to said sealing sheet in the form of protective tabs that correspond to respective tearable tabs such that said protective tabs will remain attached to said tearable tabs when said tearable tabs are torn and will be located above a corresponding pill compartment.

17. A cover sheet as defined in claim 12, wherein said sealing sheet further comprises folding lines made on said tearable tabs.

18. A cover sheet as defined in claim 16, wherein said tearable tab tongue portions are wider than said protective tab tongue portions.

19. A cover sheet as defined in claim 18, wherein said tearable tab tongue portion side segments are concave.

20. A cover sheet as defined in claim 12, wherein said tearable tab tearing lines further comprise, for each tearable tab, an intermediate segment extending between said main portion side segments and located spacedly away from said tearable tab end segment towards said tearable tab tongue portion, such that when said tearable tabs are punched in, said sealing sheet can tear along said tearable tab intermediate segment instead of or in addition to tearing along at least one of said tearable tab main portion side segments and said tearable tab main portion end segment.

21. A cover sheet as defined in claim 20, wherein said intermediate segment is located between said tearable tab main portion and said tearable tab tongue portion, and is curved and concave towards said tearable tab end segment.

22. A cover sheet as defined in claim 20, wherein said intermediate segment is located between said tearable tab main portion and said tearable tab tongue portion, and is substantially straight.

23. A pillbox kit as defined in claim 12, wherein said pill receptacle comprises receptacle tearing lines defining a number of detachable pill containers each circumscribing a corresponding said pill compartment, each said cell overlying a corresponding said pill container with said cell tearing lines being aligned with corresponding receptacle tearing lines, said pill containers comprising a peripheral wall, an upper flange linked to said peripheral wall and a top mouth opening defined interiorly of said upper flange and allowing access into said pill compartment, with said top mouth opening being larger than said tearable tab.

24. A pillbox kit as defined in claim 23, wherein said tearable tab tearing lines are aligned with an inclined portion of said peripheral wall.

25. A pillbox kit as defined in claim 24, wherein said peripheral wall comprises a chamfer near said top flange and said tearable tab tearing lines are aligned with and spaced from said chamfer.

26. A method of gaining access to a pill compartment defined within a pill container to which a sealing sheet cell is attached to seal off said pill compartment, said sealing sheet cell circumscribed by borders and comprising tearable tab tearing lines that are disposed to form a tearable tab, said tearable tab tearing lines comprising:
main portion side segments that define a tearable tab main portion therebetween;
tongue portion side segments that define a tearable tab tongue portion therebetween, said tearable tab tongue portion further defined between said tearable tab main portion and at least one of said cell borders; and
a main portion end segment that links said main portion side segments to each other spacedly from said tongue portion, with said tearable tab main portion further defined between said main portion end segment and said tearable tab tongue portion;
wherein said method comprises tearing said tearable tab away from the remainder of said sealing sheet cell, said tearing being initiated by one of:
peeling said tearable tab at least along said tearable tab tongue portion side segments and said tearable tab main portion side segments; and
punching said tearable tab in, with said sealing sheet cell then being torn along at least one of said tearable tab main portion side segments and said tearable tab main portion end segment.

27. A method as defined in claim 26, wherein said tearable tab tearing lines further comprise, for each tearable tab, an intermediate segment extending between said main portion side segments and located spacedly from said main portion end segment towards said tearable tab tongue portion, such that when said tearable tabs are punched in, said sealing sheet can tear along said tearable tab intermediate segment in addition to or instead of at least one of said tearable tab main portion side segments and said tearable tab main portion end segment.

28. A method as defined in claim 26, wherein said cell tearing lines comprise said main portion end segments.

29. A method as defined in claim 26, wherein said main portion end segments are distinct and spaced from said cell tearing lines.
